(19) United States
(12) Patent Application Publication
(10) Pub. No.: US 2017/0084885 A1
(43) Pub. Date: Mar. 23, 2017

(54) ENERGY STORAGE APPARATUS

(71) Applicant: GS Yuasa International Ltd., Kyoto-shi (JP)

(72) Inventor: Masamitsu TONONISHI, Kyoto-shi (JP)

(21) Appl. No.: 15/261,734

(22) Filed: Sep. 9, 2016

(30) Foreign Application Priority Data
Sep. 18, 2015 (JP) 2015-186093

(51) Int. Cl. H01M 2/02; H01M 2/08; H01M 2/04

(52) U.S. Cl. CPC H01M 2/0237; H01M 2/043; H01M 2/08

(57) ABSTRACT

An energy storage apparatus includes: an energy storage device; an outer covering; a fastening member which fixes the energy storage device to the outer covering; and an adhesive element disposed between the energy storage device and the outer covering. The adhesive element fixes the energy storage device to the outer covering at a position different from a position where the fastening member fixes the energy storage device to the outer covering.

### CROSS-REFERENCE TO RELATED APPLICATIONS

This application claims the benefit of Japanese patent application No. 2015-186093, filed on Sep. 18, 2015, which is incorporated by reference.

### FIELD

The present invention relates to an energy storage apparatus provided with an energy storage device and an outer covering.

### BACKGROUND

Conventionally, as an energy storage apparatus provided with energy storage devices, there has been known the configuration where the energy storage devices are fixed to an outer covering by a fastening member (see JP 2001-283938 A, for example). In such an energy storage apparatus, the energy storage devices are fixed to the outer covering by the fastening member (fixing screw), and a portion fastened by the fastening member is sealed by a seal member.

In the above-mentioned conventional storage apparatus, there is a possibility that it becomes difficult to maintain the fixing of the energy storage devices when the fastening member is loosened. To be more specific, even in the above-mentioned energy storage apparatus where the fastened portion is sealed by the sealing member, the sealing member does not contribute to the fixing of the energy storage devices and hence, when the fastening member is loosened, there is a possibility that it becomes difficult to maintain the fixing of the energy storage devices. Further, even when the energy storage apparatus is configured such that the sealing member contributes to the fixing of the energy storage devices, since the fastening member and the sealing member are disposed at the same position, there is a possibility that the maintaining of the fixing of the energy storage devices becomes difficult.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

An object of the present invention to provide an energy storage apparatus which can maintain the fixing of energy storage devices with respect to an outer covering.

According to an aspect of the present invention, there is provided an energy storage apparatus including: an energy storage device; an outer covering; a fastening member which fixes the energy storage device to the outer covering; and an adhesive element disposed between the energy storage device and the outer covering, wherein the adhesive element fixes the energy storage device to the outer covering at a position different from a position where the fastening member fixes the energy storage device to the outer covering.

### BRIEF DESCRIPTION OF DRAWINGS

The foregoing and other features of the present invention will become apparent from the following description and drawings of an illustrative embodiment of the invention in which:

FIG. 1 is a perspective view showing an external appearance of an energy storage apparatus according to an embodiment.

FIG. 2 is an exploded perspective view showing constitutional elements of the energy storage apparatus.

FIG. 3 is an exploded perspective view showing constitutional elements of the energy storage unit.

FIG. 4 is a perspective view showing a mode where an energy storage unit and an outer covering are fixed to each other.

FIG. 5 is a cross-sectional view showing a state where the energy storage unit is fixed to the outer covering.

FIG. 6 is a cross-sectional view showing a state where an energy storage unit according to a modification 1 is fixed to an outer covering.

FIG. 7 is a perspective view showing a mode where an energy storage unit and an outer covering according to a modification 2 are fixed to each other.

### DESCRIPTION OF EMBODIMENTS

According to an aspect of the present invention, there is provided an energy storage apparatus including: an energy storage device; an outer covering; a fastening member which fixes the energy storage device to the outer covering; and an adhesive element disposed between the energy storage device and the outer covering, wherein the adhesive element fixes the energy storage device to the outer covering at a position different from a position where the fastening member fixes the energy storage device to the outer covering.

With such a configuration, the energy storage device is fixed to the outer covering by the fastening member and the adhesive element such that the fixing position by the fastening member and the fixing position by the adhesive element differ from each other and hence, the fixing of the energy storage device to the outer covering can be maintained.

The fastening member and the adhesive element may fix the energy storage device to the same wall of the outer covering.

That is, the adhesive element is disposed between the energy storage device and the wall of the outer covering to which the energy storage device is fixed by the fastening member. Due to the fixing of the energy storage device to the outer covering by the fastening member, the adhesive element is strongly adhered to both the wall and the energy storage device. Accordingly, the fixing of the energy storage device by the adhesive element can be further strengthened.

The energy storage apparatus may further include an end plate disposed on a side of the energy storage device, and the fastening member may fix the end plate to the outer covering.

With such a configuration, by fixing the end plate to the outer covering by the fastening member, the energy storage device can be easily fixed to the outer covering.

The outer covering may have a mounting portion for the fastening member which is recessed toward the end plate.

With such a configuration, the mounting portion for the fastening member is recessed and hence, the fastening member minimally projects to the outside of the energy storage apparatus. Accordingly, the occurrence of a damage or the like of the fastening member can be suppressed and hence, the energy storage device can be firmly fixed to the outer covering.

The energy storage apparatus may include a spacer which is disposed between a plurality of energy storage devices, and the adhesive element may fix the spacer to the outer covering.

With such a configuration, by fixing the spacer to the outer covering by the adhesive element, the energy storage device can be easily fixed to the outer covering.

According to the energy storage apparatus of the present invention, it is possible to maintain the fixing of the energy storage device with respect to the outer covering.

Hereinafter, an energy storage apparatus according to an embodiment of the present invention is described with reference to drawings. The embodiment described hereinafter is one preferred specific example of the present invention. In the embodiment described hereinafter, numerical values, shapes, materials, constitutional elements, the arrangement positions and connection states of the constitutional elements and the like are merely examples, and these are not intended to limit the present invention. Further, out of the constitutional elements in the embodiment described hereinafter, the constitutional elements which are not described in independent claims describing an uppermost concept are described as arbitrary constitutional elements. In the respective drawings, the respective constitutional elements are not described strictly accurately in size or the like.

### Embodiment

First, a configuration of an energy storage apparatus 1 is described.

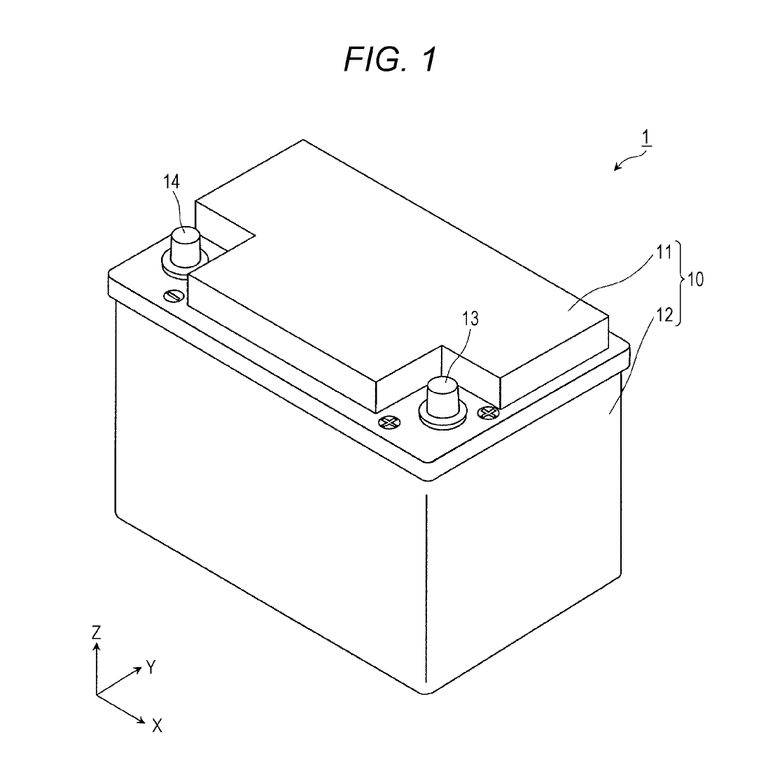

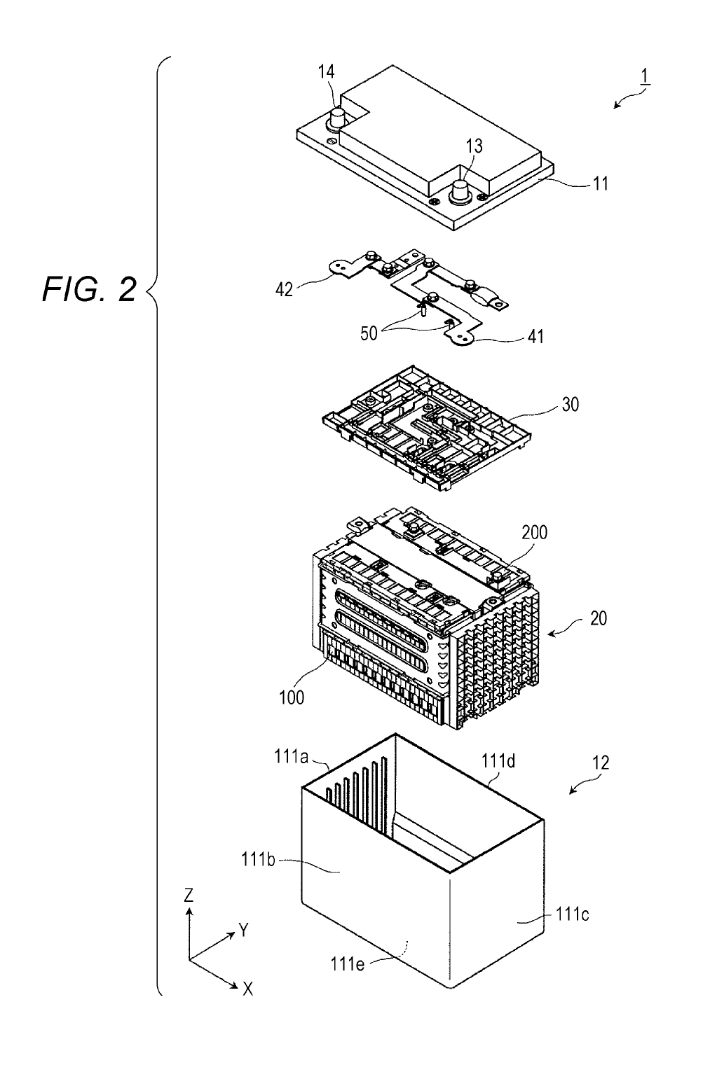

FIG. 1 is a perspective view showing an external appearance of the energy storage apparatus 1 according to an embodiment of the present invention. FIG. 2 is an exploded perspective view showing constitutional elements of the energy storage apparatus 1.

In these drawings, the Z axis direction is indicated as the vertical direction, and the description is made hereinafter using the Z axis direction as the vertical direction. However, there may be also a case where the Z axis direction is not the vertical direction depending on a mode of use and hence, the Z axis direction is not limited to the vertical direction. The same goes for drawings which are referenced hereinafter.

The energy storage apparatus 1 is an apparatus which can charge electricity from the outside of the energy storage apparatus 1 therein or can discharge electricity to the outside of the energy storage apparatus 1. For example, the energy storage apparatus 1 may be a battery module used for power storage application, power source application or the like. As shown in FIG. 1 and FIG. 2, the energy storage apparatus 1 includes: an outer covering 10 formed of a first outer covering 11 and a second outer covering 12; and an energy storage unit 20, a holder 30, bus bars 41, 42, thermistors 50 and the like which are housed in the outer covering 10.

The outer covering 10 is a container (module case) having a rectangular shape (box shape) which forms an outer covering of the energy storage apparatus 1. That is, the outer covering 10 is disposed outside the energy storage unit 20, the holder 30, the bus bars 41, 42 and the thermistors 50 and allows the energy storage unit 20 and the like to be disposed at predetermined positions in the outer covering 10 thus protecting the energy storage unit 20 and the like from an impact or the like. In this embodiment, for example, the outer covering 10 is made of an insulating resin material such as polycarbonate (PC), polypropylene (PP), polyethylene (PE), a polyphenylene sulfide resin (PPS), polybutylene terephthalate (PBT) or an ABS resin. The outer covering 10 prevents the energy storage unit 20 and the like from coming into contact with a metal member or the like disposed outside the outer covering 10.

The energy storage apparatus 1 of this embodiment is preferably used as a vehicle-mounted energy storage apparatus. However, the energy storage apparatus 1 is not limited to such an energy storage apparatus. In this embodiment, the outer covering 10 is formed to have the same size and the same shape as an outer covering of a vehicle-mounted lead-acid battery. That is, the energy storage apparatus 1 is configured to be replaceable with the lead-acid battery. The energy storage apparatus 1 outputs, for starting an engine of a vehicle, a voltage of approximately 12V in a state where the energy storage unit 20 is fully charged.

An output from the energy storage apparatus 1 may be used for, besides starting an engine, supplying electricity to accessories or assisting driving of a vehicle. The energy storage apparatus 1 may output a voltage higher than 12V (approximately 48V, for example) in a state where the energy storage unit 20 is fully charged.

The outer covering 10 includes: the first outer covering 11 forming a lid body of the outer covering 10; and the second outer covering 12 forming a body of the outer covering 10. The first outer covering 11 is a cover member having a flat rectangular shape which closes an opening of the second outer covering 12. A positive electrode external terminal 13 and a negative electrode external terminal 14 are mounted on the first outer covering 11. The energy storage apparatus 1 charges electricity from the outside therein or discharges electricity to the outside through the positive electrode external terminal 13 and the negative electrode external terminal 14. The second outer covering 12 is a bottomed rectangular cylindrical housing having the opening. The second outer covering 12 houses the energy storage unit 20, the holder 30, the bus bars 41, 42, the thermistors 50 and the like. The second outer covering 12 forms side walls 111a to 111d of the outer covering 10 and a bottom wall 111e of the outer covering 10.

The first outer covering 11 and the second outer covering 12 may be made of the same material, or may be made of different materials.

Electric equipment such as a printed circuit board and a relay is disposed in the first outer covering 11. However, the illustration of such electric equipment is omitted. The first outer covering 11 is configured to be divided into two members in the vertical direction (Z axis direction), and such electric equipment is disposed between such two members. With such a configuration, the electric equipment is protected from an impact or the like, and is also prevented from coming into contact with a metal member or the like disposed outside the first outer covering 11.

The energy storage unit 20 includes a plurality of energy storage devices 100 (twelve energy storage devices 100 in this embodiment) and a plurality of bus bars 200, and is electrically connected to the positive electrode external terminal 13 and the negative electrode external terminal 14 formed on the first outer covering 11. That is, a positive electrode terminal of any one of the plurality of energy storage devices 100 is electrically connected to the positive electrode external terminal 13 through the bus bar 200. A negative electrode terminal of any one of the plurality of energy storage devices 100 is electrically connected to the negative electrode external terminal 14 through the bus bar 200.

The energy storage unit 20 is disposed in the second outer covering 12 such that the plurality of energy storage devices 100 are arranged in a row in the X axis direction in a state where each energy storage device 100 is mounted vertically (in a state where a positive electrode terminal and a negative electrode terminal are directed upward). The energy storage unit 20 is housed in the outer covering 10 while being covered by the first outer covering 11 from above. The detailed description of the configuration of the energy storage unit 20 and the detailed description of the configuration where the energy storage unit 20 and the outer covering 10 are fixed to each other are made later.

The holder 30 is an electronic component tray. The holder 30 is provided for holding electronic components such as the bus bars 41, 42, the thermistors 50 and relays, wires (not shown in the drawing) and the like. The holder 30 also provides insulation between the bus bars 41, 42 and the like and other members. The holder 30 further regulates the positions of the bus bars 41, 42 and the like. The bus bars 41, 42 are conductive members which electrically connect the bus bars 200 disposed in the energy storage unit 20 and the positive electrode external terminal 13 and the negative electrode external terminal 14 which are formed on the first outer covering 11 to each other. The thermistors 50 are temperature sensors mounted on the holder 30 with respect to the energy storage devices 100. Since the thermistors 50 are mounted on the holder 30 after the holder 30 is mounted on the energy storage devices 100, the thermistors 50 are disposed on the holder 30 in a state where the thermistors 50 are positioned with respect to the energy storage devices 100 and are pressed to the energy storage devices 100.

Next, the configuration of the energy storage unit 20 is described in detail.

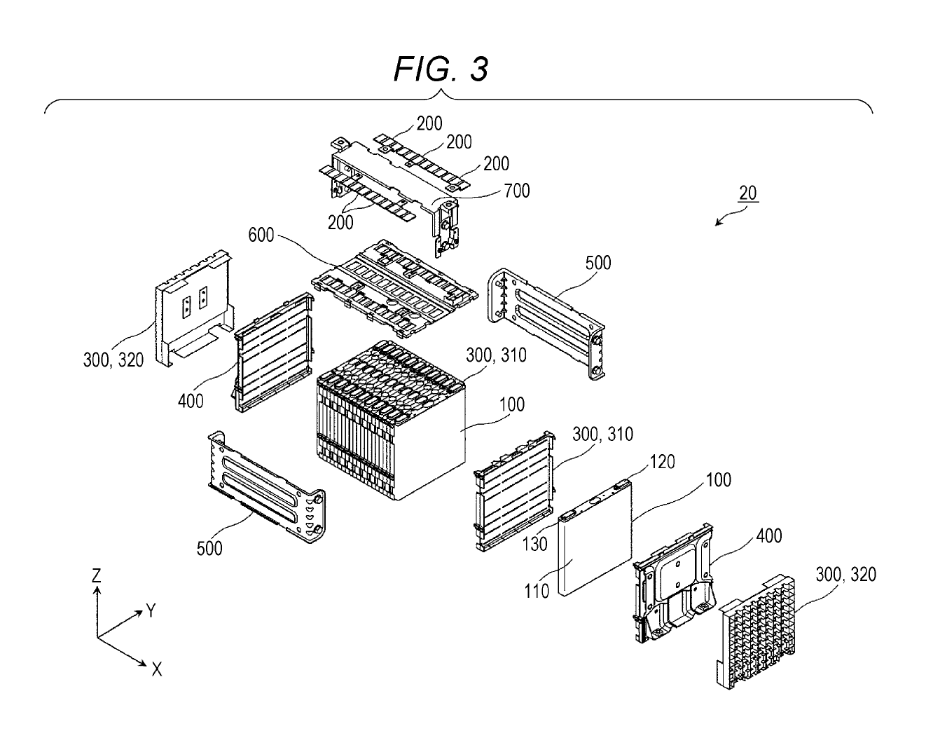

FIG. 3 is an exploded perspective view showing constitutional elements of the energy storage unit 20.

The energy storage unit 20 includes: the plurality of energy storage devices 100; the plurality of bus bars 200; a plurality of spacers 300 (a plurality of spacers 310 and a pair of spacers 320); a pair of sandwiching members 400; a plurality of binding members 500; a bus bar frame 600; and a heat insulating plate 700.

The energy storage device 100 is a secondary battery (battery) which can charge or discharge electricity. To be more specific, the energy storage device 100 is a nonaqueous electrolyte secondary battery such as a lithium ion secondary battery. The energy storage device 100 has a flat rectangular shape, and is disposed adjacently to the spacer 310. That is, the plurality of energy storage devices 100 and the plurality of respective spacers 310 are arranged in a row in the X axis direction such that the energy storage device 100 and the spacer 310 are alternately arranged. In this embodiment, twelve energy storage devices 100 and eleven spacers 310 are arranged such that the energy storage device 100 and the spacer 310 are alternately arranged. The energy storage device 100 is not limited to a nonaqueous electrolyte secondary battery, and may be a secondary battery other than a nonaqueous electrolyte secondary battery, or may be a capacitor.

As shown in FIG. 3, the energy storage device 100 includes a container 110, the positive electrode terminal 120 and the negative electrode terminal 130. An electrode assembly (power generating element), current collectors (a positive electrode current collector and a negative electrode current collector) and the like are disposed in the container 110, and a liquid such as an electrolyte solution (nonaqueous electrolyte) is sealed in the container 110. However, the detailed description of such a configuration is omitted.

The container 110 is formed of; a bottomed container body made of metal and having a rectangular cylindrical shape; and a metal-made lid portion which closes an opening of the container body. The container 110 is configured such that the inside of the container 110 is hermetically sealed by joining the lid portion and the container body to each other by welding or the like after the electrode assembly and the like are housed in the container 110. The container 110 is a rectangular parallelepiped container having a lid portion disposed on a plus side in the Z axis direction, long side surfaces disposed on side surfaces of the container on both sides in the X axis direction, short side surfaces disposed on side surfaces of the container on both sides in the Y axis direction, and a bottom surface disposed on a minus side in the Z axis direction. Although a material for forming the container 110 is not particularly limited, it is preferable that the container 110 be made of weldable metal such as stainless steel, aluminum or an aluminum alloy.

The positive electrode terminal 120 is an electrode terminal electrically connected to a positive electrode of an electrode assembly through a positive electrode current collector. The negative electrode terminal 130 is an electrode terminal electrically connected to a negative electrode of an electrode assembly through a negative electrode current collector. Both the positive electrode terminal 120 and the negative electrode terminal 130 are mounted on the lid portion of the container 110. That is, the positive electrode terminal 120 and the negative electrode terminal 130 are metal-made electrode terminals through which electricity stored in the electrode assembly is discharged to a space outside the energy storage device 100, and through which electricity is introduced into a space inside the energy storage device 100 for storing the electricity in the electrode assembly. In this embodiment, the energy storage devices 100 are disposed in a state where the positive electrode terminals 120 and the negative electrode terminals 130 are directed upward.

The bus bars 200 are electrically connected to the plurality of respective energy storage devices 100 housed in the energy storage unit 20. That is, the bus bars 200 are conductive members electrically connected to the respective electrode terminals which the plurality of energy storage devices 100 include in a state where either one of positive and negative electrode terminals of one energy storage device 100 is electrically connected to the corresponding terminal of another energy storage device 100 disposed adjacently to one energy storage device. The bus bars 200 are disposed on surfaces the respective electrode terminals which the plurality of energy storage devices 100 include, and are connected (joined) to the electrode terminals.

The spacers 300 are formed of the plurality of spacers 310 and the pair of spacers 320, and are made of an insulating resin such as PC, PP, PE, PPS, PBT or an ABS resin, for example. The spacers 310 and 320 may be made of any material as long as the spacers have an insulating property. All of spacers 310 and 320 may be made of the same material, or some of the spacers 310 and 320 may be made of different materials respectively.

The spacer 310 is a plate-like member which is disposed on a side of the energy storage device 100 (on the plus side or the minus side in the X axis direction) so as to provide insulation between the energy storage device 100 and other members. That is, the spacer 310 is arranged between two energy storage devices 100 disposed adjacently to each other so as to provide insulation between two energy storage devices 100. In this embodiment, twelve energy storage devices 100 and eleven spacers 310 are arranged in a row such that the spacer 310 is disposed between two energy storage devices 100 disposed adjacently to each other.

The spacer 310 is formed such that the spacer 310 covers an approximately half of a front surface side or a back surface side of the energy storage device 100 (an approximately half of the front surface side or the back surface side when the energy storage device 100 is divided in two in the X axis direction). That is, a recessed portion is formed on both surfaces (both surfaces in the X axis direction) of the spacer 310 on the front surface side and the back surface side respectively, and an approximately half of the energy storage device 100 is inserted into each recessed portion. With such a configuration, the spacers 310 disposed on sides of the energy storage device 100 cover the most part of the energy storage device 100. Accordingly, an insulating property between the energy storage devices 100 and other conductive members can be enhanced by the spacers 310. The spacer 310 is formed such that the spacer 310 does not cover a portion of the energy storage device 100 at which the thermistor 50 is positioned so as to allow the thermistor 50 to be brought into contact with the energy storage device 100.

One spacer 310 includes: a plate portion which is positioned between two energy storage devices 100 and extends in the Y axis direction; and flanges which are disposed on peripheries of the plate portion and extend in the X axis direction. The flange covers the short side surfaces, the bottom surface, and a portion of the lid portion of the energy storage device 100.

The spacer 320 is a plate-like member which is disposed between the sandwiching member 400 described later and the outer covering 10, and provides insulation between the sandwiching member 400 and the outer covering 10. The spacer 320 also has a function as a buffer member which protects the energy storage unit 20 when an impact is applied to the outer covering 10 from the outside. The pair of spacers 320 is disposed between the pair of sandwiching members 400 and the outer covering 10 respectively such that the pair of spacers 320 sandwiches the pair of sandwiching members 400 from both sides. The pair of spacers 320 insulates the energy storage devices 100 and the like disposed in the energy storage unit 20 and also protects the energy storage devices 100 and the like from an impact from the outside.

The sandwiching members 400 and the binding members 500 are members which press the energy storage devices 100 from the outside in the stacking direction of the electrode assembly of the energy storage device 100. That is, the sandwiching member 400 and the binding member 500 sandwich the plurality of energy storage devices 100 from both sides in the stacking direction thus pressing the plurality of respective energy storage devices 100 from both sides. In this embodiment, the stacking direction of the electrode assembly of the energy storage devices 100 means the direction that positive electrodes, negative electrodes and separators of the electrode assembly are stacked, and is equal to the direction (X axis direction) that the plurality of energy storage devices 100 are arranged in a row. That is, the plurality of energy storage devices 100 are arranged in a row in the stacking direction.

To be more specific, the sandwiching members 400 are flat plate-like members (end plates) disposed on both sides of a unit formed of the plurality of energy storage devices 100 in the X axis direction. The sandwiching members 400 hold the plurality of energy storage devices 100 and the plurality of spacers 310 by sandwiching the unit formed of the plurality of energy storage devices 100 and the plurality of spacers 310 from both sides in the arrangement direction (X axis direction) of the plurality of energy storage devices 100 and the plurality of spacers 310.

The binding member 500 is an elongated flat-plate-like member (binding bar) which has both ends thereof mounted on the sandwiching members 400, and binds the plurality of energy storage devices 100 to each other. That is, the binding member 500 is disposed so as to straddle over the plurality of energy storage devices 100 and the plurality of spacers 310 thus applying a binding force in the arrangement direction (X axis direction) of the plurality of energy storage devices 100 and plurality of spacers 310 to the plurality of energy storage devices 100 and plurality of spacers 310.

In this embodiment, two binding members 500 are disposed on both sides (both sides in the Y axis direction) of the unit formed of the plurality of energy storage devices 100, and two binding members 500 bind the plurality of energy storage devices 100 to each other by sandwiching the plurality of energy storage devices 100 from both sides. In the same manner as the sandwiching members 400, the binding members 500 are preferably made of metal such as stainless steel or aluminum, for example. However, the binding members 500 may be made of a material other than metal.

In this embodiment, each binding member 500 is formed into a U shape as viewed in a plan view. The binding member 500 is formed of a plate portion extending in the X axis direction along the short side surfaces of the plurality of energy storage devices 100; and flanges disposed on both end portions of the plate portion and extending in the Y axis direction. The flanges are fixed to the sandwiching members 400. Two binding members 500 sandwich the plurality of energy storage devices 100 from the sides of the unit formed of the plurality of energy storage devices 100. Two binding members 500 cover the short side surfaces of the plurality of energy storage devices 100. However, two binding members 500 do not cover the lid portions of the plurality of energy storage devices 100. Two binding members 500 do not cover the bottom surfaces of the plurality of energy storage devices 100.

The bus bar frame 600 is a member which can provide insulation between the bus bars 200 and other members, and can regulate the positions of the bus bars 200. Particularly, the bus bar frame 600 performs the positioning of the bus bars 200 with respect to the plurality of energy storage devices 100 disposed in the energy storage unit 20.

The heat insulating plate 700 is a plate-like member having a heat insulating property. The heat insulating plate 700 is disposed in a flow passage of an exhaust discharged from safety valves of the energy storage devices 100. The heat insulating plate 700 is disposed above the bus bar frame 600 such that the heat insulating plate 700 is positioned above the safety valves of the energy storage devices 100. When an abnormal state occurs such as a case where a gas is discharged from the safety valve of the energy storage device 100, the heat insulating plate 700 protects electric equipment such as a printed circuit board disposed above the energy storage unit 20 from heat of the gas.

Next, the configuration where the energy storage unit 20 and the outer covering 10 are fixed to each other is described in detail.

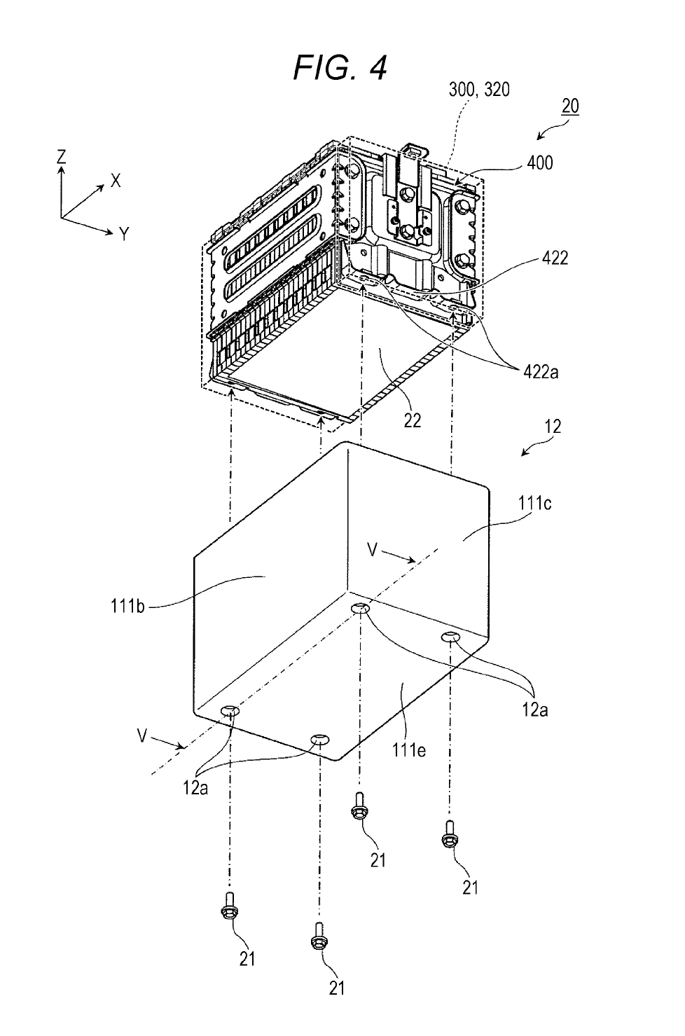

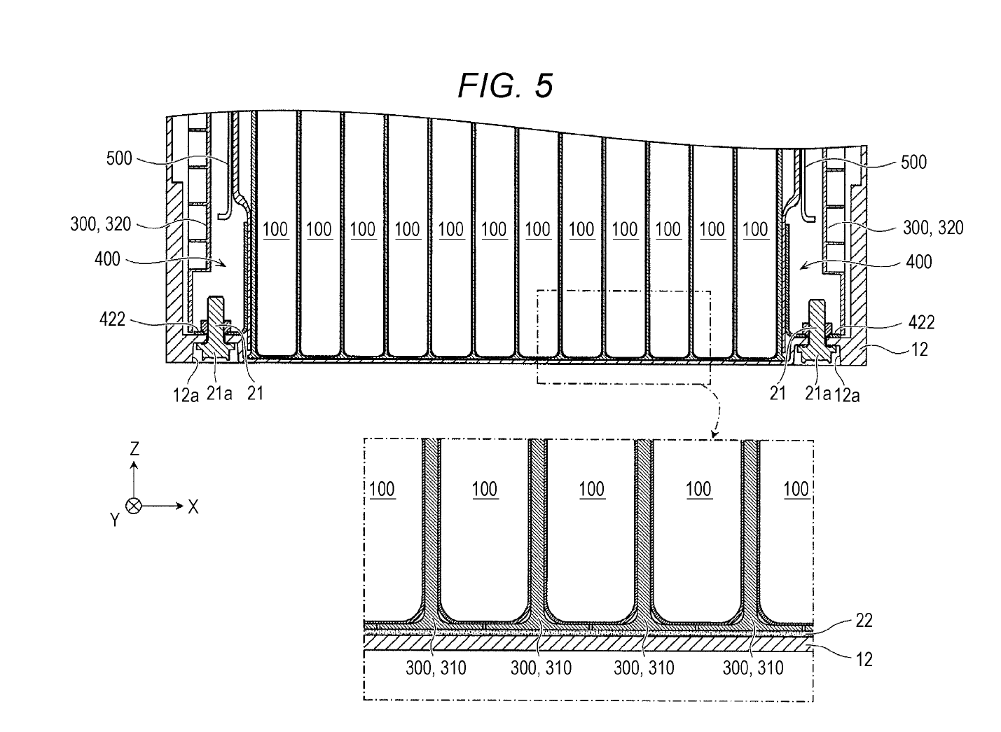

FIG. 4 is a perspective view showing a mode where the energy storage unit 20 and the outer covering 10 (second outer covering 12) are fixed to each other. FIG. 5 is a cross-sectional view showing a state where the energy storage unit 20 is fixed to the outer covering 10 (second outer covering 12). FIG. 5 is a cross-sectional view of the energy storage unit 20 taken along a line V-V in FIG. 4 which is the perspective view in a state where the energy storage unit 20 is fixed to the outer covering 10.

FIG. 4 shows the configuration of the energy storage unit 20 although the illustration of the spacers 320 is omitted. Further, in FIG. 4 and FIG. 5, among constitutional elements which form the energy storage apparatus 1, constitutional elements other than the second outer covering 12 and the energy storage unit 20 are omitted.

As shown in these drawings, the energy storage apparatus 1 includes; fastening members 21 which fix the energy storage devices 100 to the outer covering 10; and an adhesive element 22 disposed between the energy storage devices 100 and the outer covering 10. In this embodiment, the fastening members 21 and the adhesive element 22 fix the energy storage devices 100 to the same wall of the outer covering 10. To be more specific, the fastening members 21 and the adhesive element 22 fix the energy storage devices 100 to the bottom wall 111e of the outer covering 10. Hereinafter, the fastening members 21 and the adhesive element 22 are described in detail.

First, the fastening members 21 are described.

The fastening member 21 is, for example, a bolt which fixes the energy storage devices 100 to the outer covering 10. In this embodiment, four fastening members 21 are mounted on four corner portions of the approximately rectangular bottom wall 111e of the outer covering 10, and fix the unit formed of the energy storage devices 100 to the corner portions. To be more specific, the fastening members 21 fix the end plates (the sandwiching members 400 in this embodiment) disposed on both sides of the unit formed of the energy storage devices 100 to the outer covering 10 (the second outer covering 12 in this embodiment) thus fixing the energy storage devices 100 to the outer covering 10.

The number of fastening members 21 is not limited to four, and may be three or less or five or more. The fastening members 21 may not be mounted on four corner portions of the bottom wall 111e. It is sufficient that the fastening member 21 is mounted on one or more corner portions out of four corner portions. The position where the fastening member 21 is mounted is not limited to the corner portion of the bottom wall 111e, and may be a center portion of the bottom wall 111e, for example. From a viewpoint of making a stress applied to the energy storage devices 100 by the fastening members 21 uniform, it is preferable that the fastening members 21 be mounted at symmetrical positions with respect to the unit formed of the energy storage devices 100 such as two corner portions positioned on a diagonal line out of four corner portions.

The description is made hereinafter with respect to a portion of the sandwiching member 400 and a portion of the outer covering 10 which are fixed to each other by the fastening member 21.

The sandwiching member 400 has a fixing portion 422 which is a portion fixed to the outer covering 10 by the fastening members 21. The outer covering 10 has mounting portions 12a which are portions to which the sandwiching members 400 are fixed by the fastening members 21. To be more specific, the outer covering 10 (the second outer covering 12 in this embodiment) has the mounting portions 12a for the fastening members 21. Each mounting portion 12a is formed of a recessed portion which is recessed toward the sandwiching member 400.

In this embodiment, through holes 422a into each of which the fastening member 21 is inserted are formed in the fixing portions 422 and the fixing portions 422 are disposed at positions which correspond to the mounting portions 12a. To be more specific, compared to a case where the mounting portions 12a are assumed to be formed without indentation, the fixing portions 422 are disposed at a position inside the outer covering 10 by an amount corresponding to a depth of the mounting portion 12a (a depth of a recessed portion). That is, the fixing portions 422 are disposed at a position more inside the outer covering 10 than lower end portions (end portions on a minus side in the Z axis direction) of other portions of the sandwiching member 400 are.

The fixing portions 422 project toward the outside of the outer covering 10 from other portions of the sandwiching member 400. To be more specific, the fixing portions 422 project toward the outside (the plus side in the X axis direction) of the outer covering 10 along the arrangement direction of the energy storage devices 100 (X axis direction). With such a configuration, by fixing the fixing portions 422 to the outer covering 10 by the fastening members 21, it is possible to regulate the movement of the energy storage devices 100 in the arrangement direction. In other words, the outer covering 10 fixes the energy storage unit 20 in a state where the outer covering 10 houses the energy storage unit 20 therein, and the outer covering 10 imparts a binding force to the energy storage devices 100 in the arrangement direction of the energy storage devices 100.

In such a state, as described above, the plurality of energy storage devices 100 disposed in the energy storage unit 20 are pressed by the sandwiching members 400 and hence, the arrangement state (stacked structure) of the plurality of energy storage devices 100 is maintained. Accordingly, by fixing the fixing portions 422 of the sandwiching members 400 to the outer covering 10, the plurality of respective energy storage devices 100 are fixed to the outer covering 10.

The mounting portion 12a to which the fixing portion 422 is fixed is a recessed portion which is recessed toward the sandwiching member 400, and a through hole into which the fastening member 21 is inserted is formed in a bottom surface of the mounting portion 12a. That is, the mounting portion 12a forms a fastening portion where the outer covering 10 and the sandwiching member 400 are fastened to each other.

With such a configuration, by inserting the fastening members 21 into the through holes formed in the mounting portions 12a and the through holes 422a formed in the fixing portions 422 and by fastening the mounting portions 12a and the fixing portions 422 to each other, the energy storage unit 20 is fixed to the outer covering 10 in a state where the energy storage unit 20 is housed in the outer covering 10. The fastening member 21 is not limited to a bolt. For example, when the fixing portion 422 is formed of a male screw, a nut may be used as the fastening member 21.

Next, the adhesive element 22 is described.

The adhesive element 22 is disposed between the energy storage devices 100 and the outer covering 10, and fixes the energy storage devices 100 to the outer covering 10 at a position different from positions where the fastening members 21 fix the energy storage devices 100 to the outer covering 10. The adhesive element 22 is, for example, a double-coated adhesive tape such as an acrylic foam tape having a cushioning property. In this embodiment, the adhesive element 22 is disposed at the center portion of the bottom wall 111e of the outer covering 10, and fixes the energy storage devices 100 to the center portion of the bottom wall 111e. To be more specific, the adhesive element 22 is disposed between the energy storage devices 100 and the bottom wall 111e at the position different from portions where the fastening members 21 are mounted. The adhesive element 22 has an approximately rectangular shape, for example.

In this embodiment, the adhesive element 22 is disposed between the plurality of energy storage devices 100 housed in the energy storage unit 20 and the bottom wall 111e. That is, the adhesive element 22 is disposed over the plurality of energy storage devices 100 as an element used in common by these energy storage devices. To be more specific, the adhesive element 22 is disposed at the position which faces bottom surfaces of the respective energy storage devices 100. By disposing the common adhesive element 22 over the plurality of energy storage devices 100 in this manner, the positional displacement among the energy storage devices 100 can be reduced. That is, with the use of the adhesive element 22, the stacked structure of the plurality of energy storage devices 100 can be maintained.

With the provision of the sandwiching members 400 and the binding members 500, a force (binding force) in the stacking direction of the energy storage devices acts on the plurality of energy storage devices of the energy storage unit 20. The adhesive element 22 fixes the energy storage devices in the direction orthogonal to the stacking direction of the energy storage devices. With such fixing, for example, even when the energy storage apparatus 1 is mounted on a vehicle and vibrations or acceleration act on the energy storage apparatus 1, the adhesive element 22 suppresses the occurrence of an incident that some of the plurality of stacked energy storage devices are positionally displaced upward. In this embodiment, the adhesive element 22 extends over the plurality of bottom surfaces of the plurality of energy storage devices 100, and fixes these bottom surfaces to the bottom wall 111e of the outer covering and hence, the positional displacement among the energy storage devices 100 can be reduced.

In this embodiment, the adhesive element 22 does not directly fix the energy storage devices 100 to the outer covering 10 but indirectly fixes the energy storage devices 100 to the outer covering 10. To be more specific, as shown in FIG. 5, the adhesive element 22 fixes the energy storage devices 100 to the outer covering 10 by fixing the spacers 310 each of which is disposed between two adjacently disposed energy storage devices 100 to the outer covering 10 (second outer covering 12).

The adhesive element 22 having such a configuration is, for example, before the energy storage unit 20 is housed in the outer covering 10, adhered to a bottom surface or to a side surface of the energy storage unit 20, or to an inner surface of the outer covering 10. Accordingly, compared to a case where the adhesive element 22 is disposed after the energy storage unit 20 is housed in the outer covering 10, the adhesive element 22 can be easily disposed between the energy storage devices 100 and the outer covering 10.

Particularly, in this embodiment, the adhesive element 22 is disposed between the energy storage devices 100 and the bottom wall 111e of the outer covering 10 and hence, in housing the energy storage unit 20 in the outer covering 10, the adhered adhesive element 22 minimally interrupts the housing operation. Accordingly, assembling workability of the energy storage apparatus 1 can be enhanced.

The adhesive element 22 is not limited to a double-coated adhesive tape having a cushioning property, and may be a double-coated adhesive tape other than such a double-coated adhesive tape. The adhesive element 22 may be an adhesive agent. Alternatively, the adhesive element 22 may be an adhesive element having the surface fastener structure which allows the adhesion in a detachable manner which is referred to as Magic Tape (registered trademark) or Velcro tape (registered trademark).

The shape of the adhesive element 22 is not limited to an approximately rectangular shape, and may be a polygonal shape or an elliptical shape other than the approximately rectangular shape, for example. Further, the adhesive element 22 may be formed of one sheet of double-coated adhesive tape, or may be formed of plural sheets of double-coated adhesive tape. From a viewpoint of maintaining the above-mentioned stacked structure, it is preferable that the adhesive element 22 be disposed over the plurality of energy storage devices 100. However, the adhesive element 22 may be disposed over some energy storage devices 100 or may be disposed only on one energy storage device 100.

As has been described heretofore, according to the energy storage apparatus 1 of this embodiment, the energy storage devices 100 are fixed to the outer covering 10 by the fastening members 21 and the adhesive element 22 such that the fixing positions by the fastening members 21 and the fixing position by the adhesive element 22 differ from each other and hence, the fixing of the energy storage devices 100 to the outer covering 10 can be maintained.

For example, in the case where the adhesive element 22 is not provided, there may be a case where the fastening member 21 which fixes the energy storage devices 100 is loosened due to a load applied to the energy storage devices 100 by vibrations or the like of the energy storage apparatus 1. In this case, it becomes difficult to maintain the fixing of the energy storage devices 100 by the fastening members 21. On the other hand, in this embodiment, the adhesive element 22 which fixes the energy storage devices 100 is disposed at the position different from the positions where the fastening members 21 fix the energy storage devices 100 to the outer covering 10 and hence, a load applied to the energy storage devices 100 by the vibrations or the like can be reduced. Accordingly, the fastening members 21 are minimally loosened and hence, the fixing of the energy storage devices 100 can be maintained.

According to the energy storage apparatus 1 of this embodiment, the fastening members 21 and the adhesive element 22 fix the energy storage devices 100 to the same wall (the bottom wall 111e in this embodiment) of the outer covering 10. That is, the adhesive element 22 is disposed between the energy storage devices 100 and the wall of the outer covering 10 to which the energy storage devices 100 are fixed by the fastening members 21. Accordingly, due to the fixing of the energy storage devices 100 to the outer covering 10 by the fastening members 21, the adhesive element 22 is strongly adhered to both the wall of the outer covering 10 and the energy storage devices 100. To be more specific, due to the fixing of the energy storage devices 100 by the fastening members 21, the adhesive element 22 is pressed by the wall of the outer covering 10 and the energy storage devices 100 from both sides so that the adhesive element 22 is more strongly adhered to both the wall of the outer covering 10 and the energy storage devices 100. Accordingly, the fixing of the energy storage devices 100 by the adhesive element 22 can be further strengthened.

According to the energy storage apparatus 1 of this embodiment, by fixing the end plates (the sandwiching members 400 in this embodiment) to the outer covering 10 by the fastening members 21, the energy storage devices 100 can be easily fixed to the outer covering 10. Further, the energy storage unit 20 can be housed in the outer covering 10 in a state where the energy storage unit 20 is assembled and hence, assembling steps of the energy storage apparatus 1 can be simplified.

According to the energy storage apparatus 1 of this embodiment, the mounting portion 12a for the fastening member 21 is recessed and hence, the fastening member 21 minimally projects to the outside of the energy storage apparatus 1. To be more specific, as shown in FIG. 5, a head portion 21a (an end portion on the outer side of the outer covering 10) of the fastening member 21 is disposed in the mounting portion 12a. Accordingly, the occurrence of a damage or the like of the fastening member 21 can be suppressed and hence, the energy storage devices 100 can be firmly fixed to the outer covering 10.

Particularly, in this embodiment, the fixing portions 422 of the sandwiching member 400 are disposed more inside than the lower end portions (end portions on the minus side in the Z axis direction) of other portions of the sandwiching member 400. Accordingly, end edges (the end edges on the minus side in the Z axis direction) of the lower end portions are disposed at positions relatively close to an inner wall of the outer covering 10. Accordingly, as shown in FIG. 5, the plurality of energy storage devices 100 can be disposed at positions relatively close to the inner wall. That is, with such a configuration, while a large space for arranging the energy storage devices 100 is ensured in the outer covering 10, it is possible to suppress the projection of the fastening members 21 to the outside of the outer covering 10.

According to the energy storage apparatus 1 of this embodiment, by fixing the spacers 310 to the outer covering 10 by the adhesive element 22, the energy storage devices 100 can be easily fixed to the outer covering 10.

### (Modification 1)

Next, a modification 1 of the above-mentioned embodiment is described. In the above-mentioned embodiment, the energy storage devices 100 are fixed to the outer covering 10 by fixing the spacers 310 to the outer covering 10 (the second outer covering 12 in the above-mentioned embodiment) using the adhesive element 22. However, in this modification, an adhesive element 22 directly fixes energy storage devices 100 to the outer covering 10.

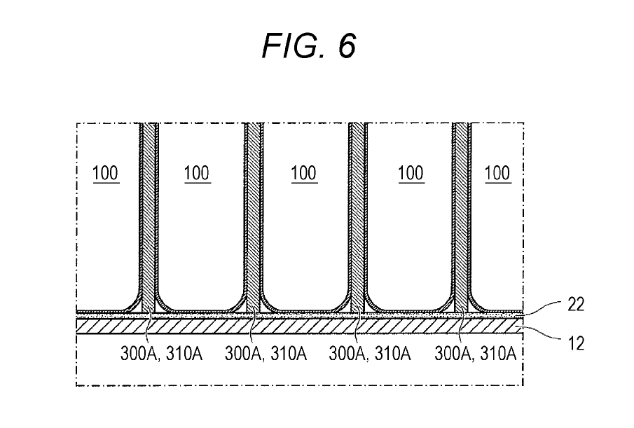

FIG. 6 is a cross-sectional view showing the configuration in a state where an energy storage unit according to the modification 1 of the embodiment of the present invention is fixed to the outer covering 10 (second outer covering 12). To be more specific, FIG. 6 is a partially enlarged view of a cross-sectional view taken along a line V-V in FIG. 4 which is the perspective view in a state where the energy storage unit is fixed to the outer covering 10.

As shown in FIG. 6, spacers 300A in this modification include flat plate-like spacers 310A in place of the spacers 310 in the embodiment. To be more specific, the recessed portion is formed on both surfaces (both surfaces in the X axis direction) of the front surface side and the back surface side of each spacer 310 in the embodiment, and an approximately half of the energy storage device 100 disposed on the front surface side or on the back surface side of the spacer 310 is inserted into the recessed portion. On the other hand, in the modification 1, the spacers 310A are formed into a flat plate-like shape and hence, the energy storage devices 100 are disposed in a state where the bottom surfaces of the energy storage devices 100 face an inner surface of the outer covering 10 without being covered by the spacers 310A.

With such a configuration, in this modification, the adhesive element 22 disposed between the energy storage devices 100 and the outer covering 10 is adhered to the energy storage devices 100. That is, the adhesive element 22 directly fixes the energy storage devices 100 to the outer covering 10.

The energy storage apparatus according to this modification having the above-mentioned configuration can also acquire substantially the same advantageous effects as the above-mentioned embodiment. That is, the energy storage devices 100 are fixed to the outer covering 10 by fastening members 21 and the adhesive element 22 such that the fixing positions by the fastening members 21 and the fixing position by the adhesive element 22 differ from each other and hence, the fixing of the energy storage devices 100 to the outer covering 10 can be maintained.

### (Modification 2)

Next, a modification 2 of the above-mentioned embodiment is described. In the above-mentioned embodiment, the adhesive element 22 fixes the energy storage devices 100 to the same wall (the bottom wall 111e in the above-mentioned embodiment) of the outer covering 10 to which the energy storage devices 100 are fixed by the fastening members 21. In this modification, however, an adhesive element fixes the energy storage devices 100 to a wall of the outer covering 10 different from the above-mentioned same wall to which the energy storage devices 100 are fixed by the fastening members 21.

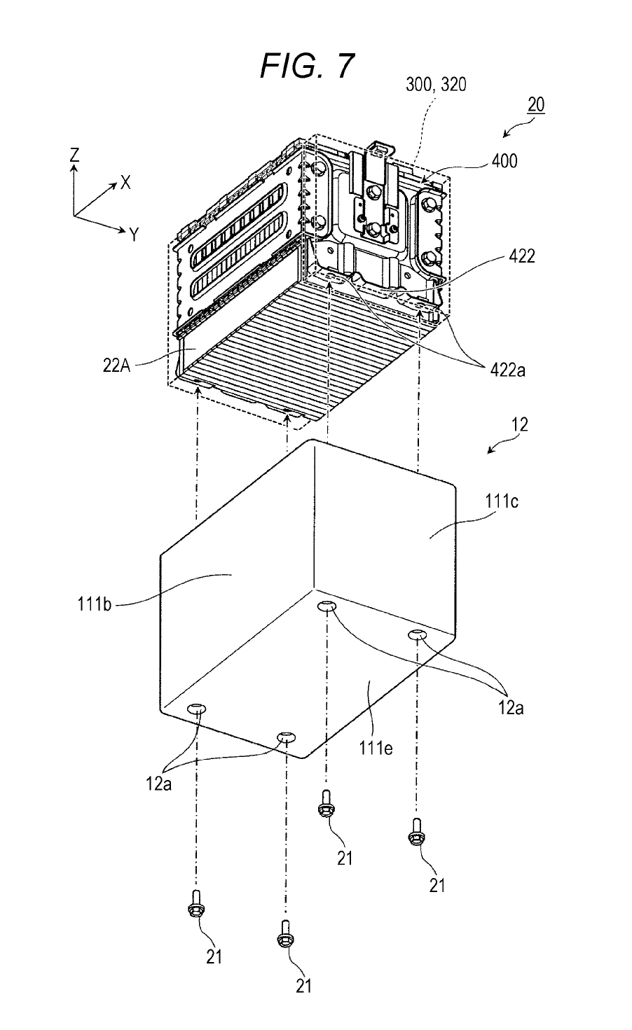

FIG. 7 is a perspective view showing a mode where an energy storage unit 20 and the outer covering 10 (second outer covering 12) according to the modification 2 of the embodiment of the present invention are fixed to each other. In the same manner as FIG. 4, FIG. 7 shows the configuration of the energy storage unit 20 in a see-through manner such that spacers 320 are not shown, and the illustration of members which constitute the energy storage apparatus other than the second outer covering 12 and the energy storage unit 20 is omitted.

As shown in FIG. 7, an adhesive element 22A in this modification is disposed between the energy storage devices 100 and a wall (a side wall 111b in this modification) of the outer covering 10 different from a wall (a bottom wall 111e in this modification) of the outer covering 10 to which the energy storage devices 100 are fixed by fastening members 21.

In other words, in the above-mentioned embodiment, the energy storage devices 100 are fixed to the same wall of the outer covering 10 at the different positions by the fastening members 21 and the adhesive element 22. On the other hand, in this modification, the energy storage devices 100 are fixed by the fastening members 21 and the adhesive element 22A such that the wall (position) of the outer covering 10 to which the fixing by the fastening members 21 is made and the wall (position) of the outer covering 10 to which the fixing by the adhesive element 22A is made differ from each other.

The energy storage apparatus according to this modification having the above-mentioned configuration can also acquire substantially the same advantageous effects as the above-mentioned embodiment. That is, the energy storage devices 100 are fixed to the outer covering 10 by the fastening members 21 and the adhesive element 22A such that the fixing positions by the fastening members 21 and the fixing position by the adhesive element 22A differ from each other and hence, the fixing of the energy storage devices 100 to the outer covering 10 can be maintained.

### (Other Modifications)

Although the energy storage apparatuses according to the embodiment of the present invention and the modifications of the embodiment have been described heretofore, the present invention is not limited to the above-mentioned embodiment and the modifications of the embodiment. That is, it should be construed that the embodiment and the modifications of the embodiment disclosed in this specification are only for an exemplifying purpose in all aspects and are not limited. The scope of the present invention is not designated by the above-mentioned description but is designated by Claims, and it is intended that all modifications which fall within the meaning and the scope equivalent to Claims are also included in the scope of the present invention. Further, the configurations which are made by arbitrarily combining the respective constitutional elements which the above-mentioned embodiment and the modifications of the embodiment include are also included in the scope of the present invention.

For example, in the above-mentioned embodiment and modifications, the energy storage apparatus includes the pair of sandwiching members 400. However, the number of sandwiching members 400 is not particularly limited, and may be one or three or more, for example. When the energy storage apparatus includes one sandwiching member, the sandwiching member 400 may sandwich the energy storage devices 100 in cooperation with the inner wall of the outer covering 10 which the sandwiching member 400 faces with the energy storage devices 100 interposed therebetween. The sandwiching member 400 may not sandwich the energy storage devices 100. It is sufficient that the sandwiching member 400 is formed of an end plate disposed on a side of the unit formed of the energy storage devices 100.

In the above-mentioned embodiment and modifications, four fastening members 21 fix the pair of sandwiching members 400 to the outer covering 10. However, the fastening members 21 may fix only either one of the pair of sandwiching members 400 to the outer covering 10. The fastening members 21 may fix the end plate to the outer covering 10, or may fix a member (binding member 500 or the like) other than the sandwiching member 400 and the end plate to the outer covering 10.

In the above-mentioned embodiment and modifications, the outer covering 10 has the mounting portions 12a each of which is formed of a recessed portion and is recessed toward the end plate. However, the mounting portions 12a may not be formed into a recessed shape. For example, the mounting portion 12a may be formed coplanar with an outer surface of the bottom wall 111e of the second outer covering 12. Further, in the above-mentioned embodiment and modifications, the recessed portions are formed on the bottom wall 111e of the second outer covering 12. However, the positions of the recessed portions are not limited to such positions. For example, the recessed portions may be formed on any one of the side walls 111a to 111d of the second outer covering 12, or may be formed on the first outer covering 11.

In the above-mentioned embodiment and modifications, the energy storage apparatus includes the plurality of energy storage devices 100. However, the number of energy storage devices 100 is not particularly limited, and it is sufficient that the energy storage apparatus includes one or more energy storage devices 100.

In the above-mentioned embodiment and modifications, the outer covering 10 is formed of a box-shaped container. However, a shape of the outer covering 10 is not limited to such a shape. For example, the outer covering may have a cylindrical shape where a wall which forms a part of a plurality of walls for forming the box-shaped container is cut away. For example, the outer covering may be formed of a pair of walls which face each other with the energy storage devices 100 interposed therebetween; and columnar members or beam members which extends between and over the pair of walls. For example, the outer covering may be formed of a plate-like base plate on which the plurality of energy storage devices 100 are placed and fixed.

The present invention is applicable to an energy storage apparatus or the like provided with energy storage devices and an outer covering.

What is claimed is:

1. An energy storage apparatus comprising:
an energy storage device;
an outer covering;
a fastening member which fixes the energy storage device to the outer covering; and
an adhesive element disposed between the energy storage device and the outer covering,
wherein the adhesive element fixes the energy storage device to the outer covering at a position different from a position where the fastening member fixes the energy storage device to the outer covering.

2. The energy storage apparatus according to claim 1, wherein the energy storage device comprises a plurality of energy storage devices which are stacked in a first direction, and
the adhesive element fixes the plurality of energy storage devices to the outer covering in a second direction orthogonal to the first direction.

3. The energy storage apparatus according to claim 2, wherein the adhesive element extends over the plurality of energy storage devices, and fixes the plurality of energy storage devices to the outer covering.

4. The energy storage apparatus according to claim 1, wherein the fastening member and the adhesive element fix the energy storage device to a same wall of the outer covering.

5. The energy storage apparatus according to claim 4, wherein a position where the energy storage device is fixed by the fastening member is, as viewed in a plan view of the wall, disposed outside a position where the energy storage device is fixed by the adhesive element.

6. The energy storage apparatus according to claim 2, further comprising an end plate disposed on a side of a unit formed of the plurality of energy storage devices, wherein the fastening member fixes the end plate to the outer covering.

7. The energy storage apparatus according to claim 6, wherein the outer covering has a mounting portion for the fastening member which is recessed toward the end plate.

8. The energy storage apparatus according to claim 1, wherein the outer covering includes a first outer covering and a second outer covering both of which are made of a resin, and
the first outer covering includes a positive electrode external terminal and a negative electrode external terminal.

9. The energy storage apparatus according to claim 8, wherein the second outer covering includes a second wall which faces a first wall of the first outer covering on which the positive electrode external terminal and the negative electrode external terminal are mounted, and
the adhesive element fixes the energy storage device to the second wall at a position different from a position where the fastening member fixes the energy storage device to the outer covering.

10. The energy storage apparatus according to claim 2, further comprising a spacer disposed between the plurality of energy storage devices, wherein the adhesive element fixes the spacer to the outer covering.

11. The energy storage apparatus according to claim 10, wherein
the spacer includes: a plate portion which is positioned between two energy storage devices; and a flange which is disposed on a periphery of the plate portion and extends in the first direction, and
the adhesive element fixes the flange to the outer covering.
